(19) United States
(12) Patent Application Publication
(10) Pub. No.: US 2019/0386395 A1
(43) Pub. Date: Dec. 19, 2019

(54) ANTENNA DEVICE AND RADIO DEVICE

(71) Applicant: Panasonic Intellectual Property Management Co., Ltd., Osaka (JP)

(72) Inventors: YUICHI KASHINO, Ishikawa (JP); JUNJI SATO, Tokyo (JP)

(21) Appl. No.: 16/379,849

(22) Filed: Apr. 10, 2019

(30) Foreign Application Priority Data
Jun. 18, 2018 (JP) 2018-115428

(51) Int. Cl. H01Q 19/19; H01Q 25/00; H01Q 15/14; H01Q 19/12; G01S 7/03

(52) U.S. Cl. CPC H01Q 19/19; H01Q 25/007; G01S 7/032; H01Q 19/12; H01Q 15/147

(57) ABSTRACT

An antenna device includes: a first antenna that is provided on a board and forms a main lobe in a first direction along a plane of the board; a second antenna that is provided on the board and forms a main lobe in a second direction along the plane of the board, the second direction forming an angle of greater than 90 degrees and equal to or less than 180 degrees with respect to the first direction; a first reflecting mirror that changes a traveling direction of radio waves radiated in the first direction from the first antenna into a third direction; and a second reflecting mirror that changes a traveling direction of radio waves entering from a fourth direction into the second direction.

### BACKGROUND

### 1. Technical Field

The present disclosure relates to an antenna device and a radio device.

### 2. Description of the Related Art

Recently, there has been a discussion on use of an antenna device supporting a high-frequency band (radio frequency band) such as a terahertz band in a radio communication system or a radar system. In the high-frequency band such as the terahertz band, a large power loss occurs in a feed line connecting an antenna to a radio unit that performs frequency conversion; thus, the antenna device is designed to have a short feed line.

For example, Japanese Unexamined Patent Application Publication (Translation of PCT Application) No. 2000-515242 (PTL 1) discloses a radar sensor in which a transmitting antenna element and a receiving antenna element are oriented in different directions from each other. In the radar sensor disclosed in PTL 1, connecting lines that connect the antenna elements to an oscillator are short.

### SUMMARY

However, since the transmitting antenna element and the receiving antenna element are arranged in the directions orthogonal to each other in the radar sensor disclosed in PTL 1, transmission waves radiated from the transmitting antenna element partially deflect to the receiving antenna element, and this deteriorates the isolation characteristic between the transmitting antenna element and the receiving antenna element.

One non-limiting and exemplary embodiment provides an antenna device and a radio device capable of improving the isolation characteristic.

In one general aspect, the techniques disclosed here feature an antenna device including: a first antenna that is provided on a board and forms a main lobe in a first direction along a plane of the board; a second antenna that is provided on the board and forms a main lobe in a second direction along the plane of the board, the second direction forming an angle of greater than 90 degrees and equal to or less than 180 degrees with respect to the first direction; a first reflecting mirror that changes a traveling direction of radio waves radiated in the first direction from the first antenna into a third direction; and a second reflecting mirror that changes a traveling direction of radio waves entering from a fourth direction into the second direction.

According to one general aspect of the present disclosure, it is possible to provide an antenna device and a radio device capable of improving the isolation characteristic.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a diagram that illustrates an example of a radar sensor;

FIG. 2A is a perspective view that illustrates an exterior of an antenna device according to an embodiment of the present disclosure;

FIG. 2B is an exploded perspective view that illustrates the antenna device according to the embodiment of the present disclosure;

FIG. 2C is a front view that illustrates the antenna device according to the embodiment of the present disclosure;

FIG. 2D is a side view that illustrates the antenna device according to the embodiment of the present disclosure;

FIG. 2E is a cross-sectional view taken along the line IIE-IIE in FIG. 2A;

FIG. 3A is a top view that illustrates an antenna board according to the embodiment of the present disclosure;

FIG. 3B is a bottom view that illustrates the antenna board according to the embodiment of the present disclosure;

FIG. 3C is a front view that illustrates the antenna board according to the embodiment of the present disclosure;

FIG. 3D is a side view that illustrates the antenna board according to the embodiment of the present disclosure;

FIG. 4 is a diagram that illustrates an example of operations of the antenna device according to the embodiment of the present disclosure;

FIG. 5A is a diagram that illustrates an example of a directionality pattern in a transmitting operation of the antenna device according to the embodiment of the present disclosure;

FIG. 5B is a diagram that illustrates an example of a directionality pattern in a receiving operation of the antenna device according to the embodiment of the present disclosure;

FIG. 6 is a top view that illustrates an example of an antenna board according to a modification 1 of the embodiment of the present disclosure;

FIG. 7 is a top view that illustrates an example of an antenna board according to a modification 2 of the embodiment of the present disclosure;

FIG. 8 is a diagram that illustrates a first example of the antenna device including the antenna board illustrated in FIG. 7;

FIG. 9 is a diagram that illustrates a second example of the antenna device including the antenna board illustrated in FIG. 7;

FIG. 10A is a diagram that illustrates an example of the isolation characteristic of the antenna device of the modification 2 of the embodiment of the present disclosure; and

FIG. 10B is a diagram that illustrates an example of the isolation characteristic of a comparative example of FIG. 10A.

### DETAILED DESCRIPTION

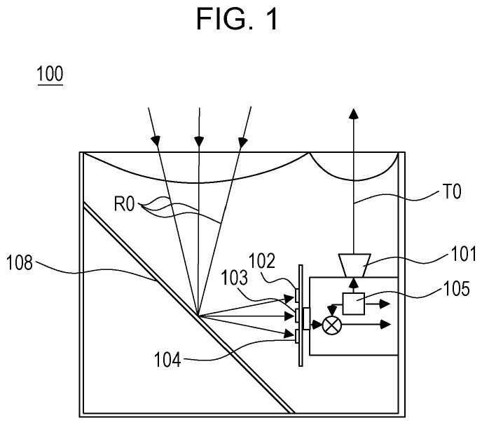

FIG. 1 is a diagram that illustrates an example of a radar sensor 100. The radar sensor 100 in FIG. 1 is the radar sensor disclosed in PTL 1, for example.

The radar sensor 100 includes a transmitting antenna element 101, receiving antenna elements 102 to 104, an oscillator 105, and a deflecting mirror 108.

In the radar sensor 100, the receiving antenna elements 102 to 104 are arranged outside a radiation diaphragm TO of the transmitting antenna element 101 in order to shorten a connecting line that connects the transmitting antenna element 101 to the oscillator 105 and connecting lines that connect the receiving antenna elements 102 to 104 to the oscillator 105. The transmitting antenna element 101 and the receiving antenna elements 102 to 104 are oriented in different directions from each other. The provided deflecting mirror 108 deflects radar beams RO that will enter the receiving antenna elements 102 to 104 into a desired direction.

The configuration illustrated in FIG. 1 makes it possible to shorten the connecting lines that connect the antenna elements to the oscillator, and thus the power loss is reduced.

However, the configuration illustrated in FIG. 1 is complicated because the transmitting antenna element 101 and the receiving antenna elements 102 to 104 are arranged and fixed on surfaces orthogonal to each other. In addition, since a radiation direction of the transmission waves from the transmitting antenna element 101 is orthogonal to a direction of reception waves entering the receiving antenna elements 102 to 104, the transmission waves deflect to the receiving antenna elements 102 to 104. The transmission waves thus deflected deteriorates the isolation characteristic between the transmitting antenna element 101 and the receiving antenna elements 102 to 104.

The present disclosure is made in view of the above problems to provide an antenna device and a radio device capable of improving the isolation characteristic between a transmitting antenna element and a receiving antenna element.

Hereinafter, embodiments of the present disclosure are described in detail with reference to the drawings. The embodiments described below are examples, and the present disclosure is not limited by these embodiments.

### EMBODIMENT

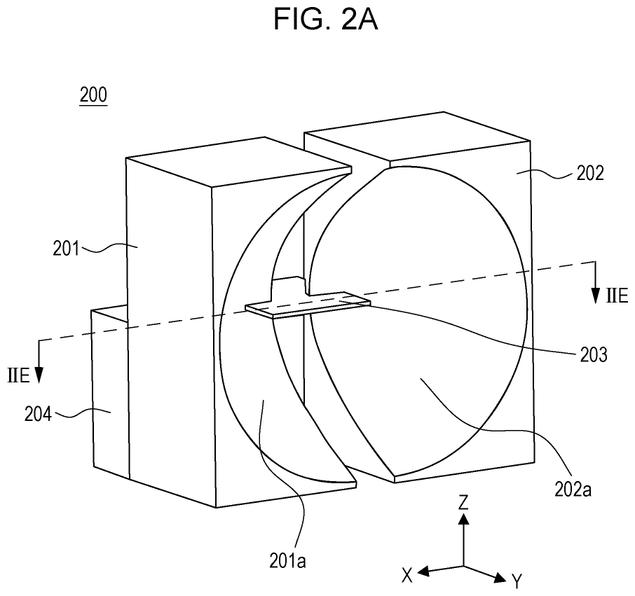

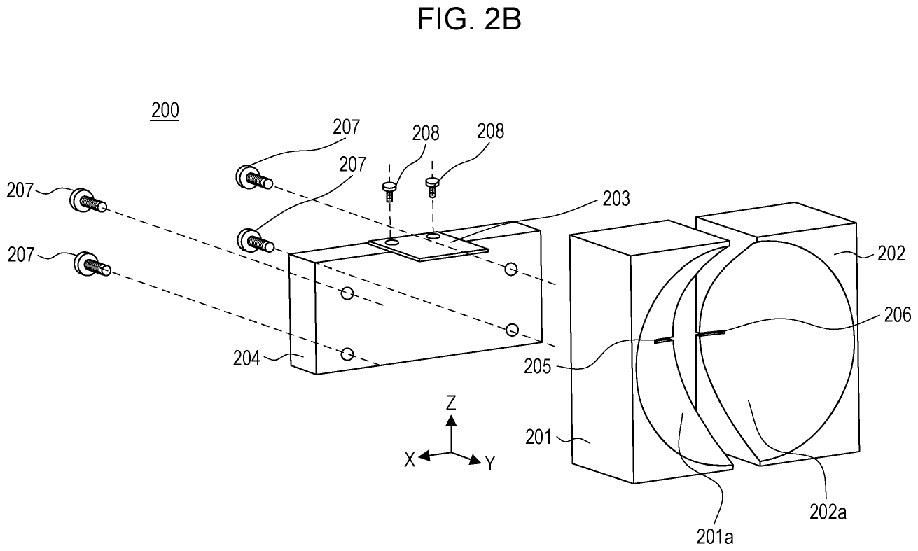

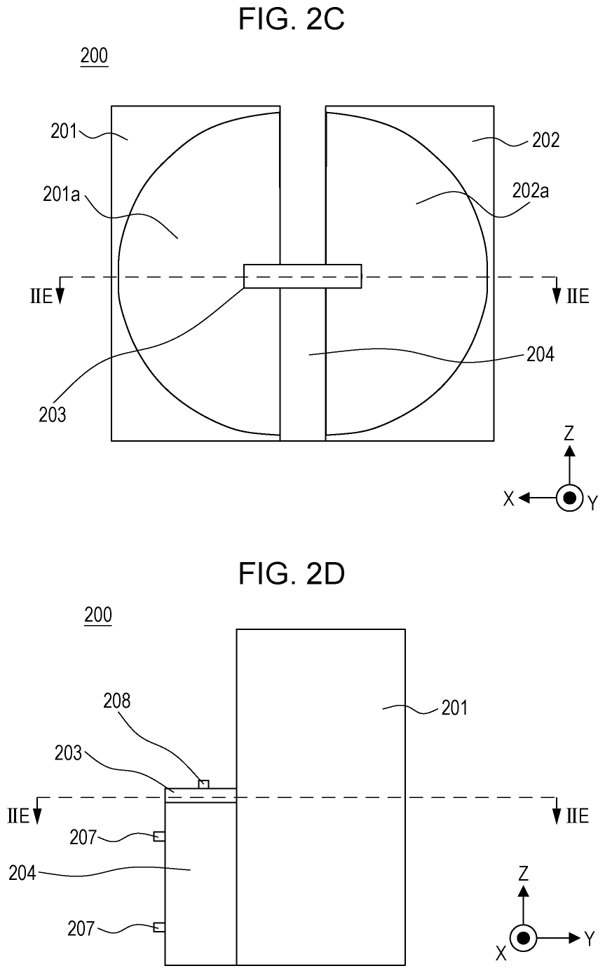

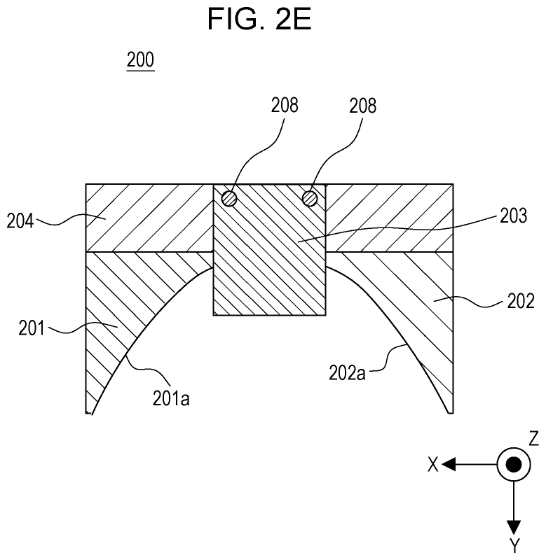

FIG. 2A is a perspective view that illustrates an exterior of an antenna device 200 according to this embodiment. FIG. 2B is an exploded perspective view that illustrates the antenna device 200 according to this embodiment. FIG. 2C is a front view that illustrates the antenna device 200 according to this embodiment. FIG. 2D is a side view that illustrates the antenna device 200 according to this embodiment. FIG. 2E is a cross-sectional view taken along the line IIE-IIE in FIGS. 2A, 2C, and 2D.

FIGS. 2A to 2E each illustrates an X-axis, Y-axis, and Z-axis. The front view in FIG. 2C illustrates the antenna device 200 seen from a Y-axis positive direction, and the side view in FIG. 2D illustrates the antenna device 200 seen from an X-axis positive direction.

The antenna device 200 includes a first reflecting unit 201, a second reflecting unit 202, and an antenna board 203. The positions of the first reflecting unit 201, the second reflecting unit 202, and the antenna board 203 are fixed by, for example, screwing them on a fix unit 204.

The first reflecting unit 201 and the second reflecting unit 202 are made of metal, for example. The first reflecting unit 201 includes a first reflecting mirror 201a at a position facing the Y-axis positive direction. The second reflecting unit 202 includes a second reflecting mirror 202a at a position facing the Y-axis positive direction.

The first reflecting mirror 201a changes a traveling direction of radio waves (transmission waves) radiated from a transmitting antenna element included in the antenna board 203.

The second reflecting mirror 202a changes a traveling direction of radio waves (reception waves) entering the antenna device 200. The radio waves traveling in the changed direction are received by a receiving antenna element included in the antenna board 203.

The first reflecting unit 201 may have any configuration as long as it includes a metal surface. For example, the first reflecting unit 201 may be molded with resin such as acrylonitrile-butadiene-styrene (ABS) resin and/or polycarbonate. Metal plating may be applied to a surface of the molded first reflecting unit 201 to form the first reflecting mirror 201a. The same applies to the second reflecting unit 202.

The materials of the first reflecting unit 201 and the second reflecting unit 202 are not limited to the above example. The first reflecting mirror 201a and the second reflecting mirror 202a are not limited to metal as long as they have configurations capable of reflecting the radio waves. The first reflecting mirror 201a and the second reflecting mirror 202a may be formed as a single member (e.g., a single reflecting unit).

The antenna board 203 includes a board formed by applying copper foil to a dielectric, for example. Patterns of the antenna elements and the transmission lines are formed by etching on the board. The antenna board 203 at least includes the transmitting antenna element and the receiving antenna element. An example of the configuration of the antenna board 203 is described later.

Next, an example of assembling of the antenna device 200 is described.

The antenna device 200 is assembled so that the antenna board 203 is fixed at a predetermined position between the first reflecting mirror 201a and the second reflecting mirror 202a.

For example, as illustrated in FIG. 2B, the first reflecting unit 201, the second reflecting unit 202, and the antenna board 203 are fixed on the fix unit 204.

For example, the antenna board 203 is fixed on the fix unit 204 with screws 208. The antenna board 203 is inserted to a notch 205 of the first reflecting unit 201 and a notch 206 of the second reflecting unit 202 from a Y-axis negative direction. With the antenna board 203 inserted in their notches, the first reflecting unit 201 and the second reflecting unit 202 are fixed on the fix unit 204 with screws 207.

This embodiment presents an example of fixing the first reflecting unit 201, the second reflecting unit 202, and the antenna board 203 with screws; however, the present disclosure is not limited thereto. For example, the first reflecting unit 201, the second reflecting unit 202, and the antenna board 203 may be fixed on the fix unit 204 with an adhesive. Otherwise, the first reflecting unit 201, the second reflecting unit 202, and the antenna board 203 may be each provided with a fitting portion so as to be fixed by fitting their fitting portions into corresponding fitting portions on the fix unit 204.

As long as an assembling method capable of fixing positions of the first reflecting unit 201, the second reflecting unit 202, and the antenna board 203 is adopted, they do not have to be fixed on the fix unit 204. In this case, the fix unit 204 does not have to be used.

Next, a configuration of the antenna board 203 is described.

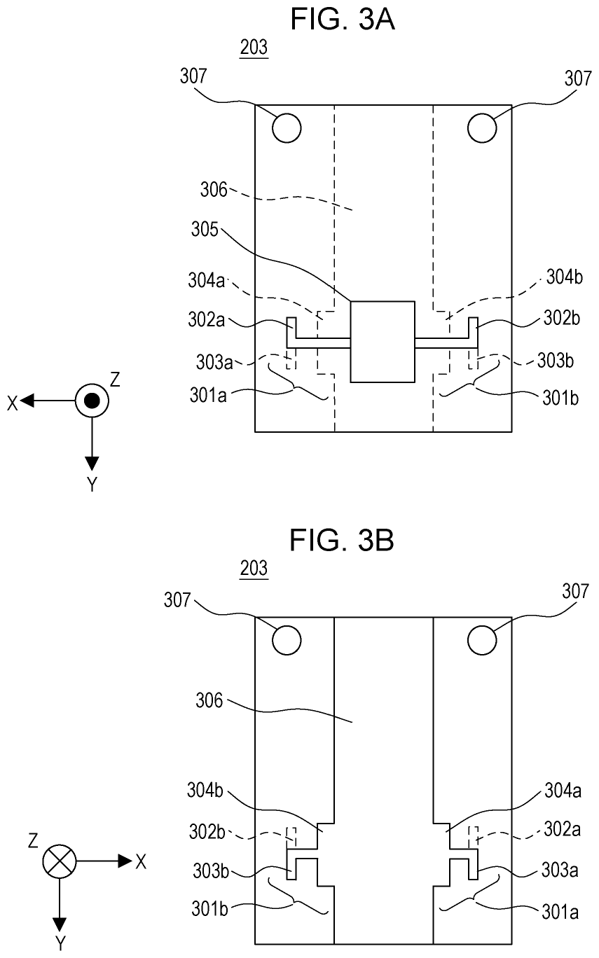

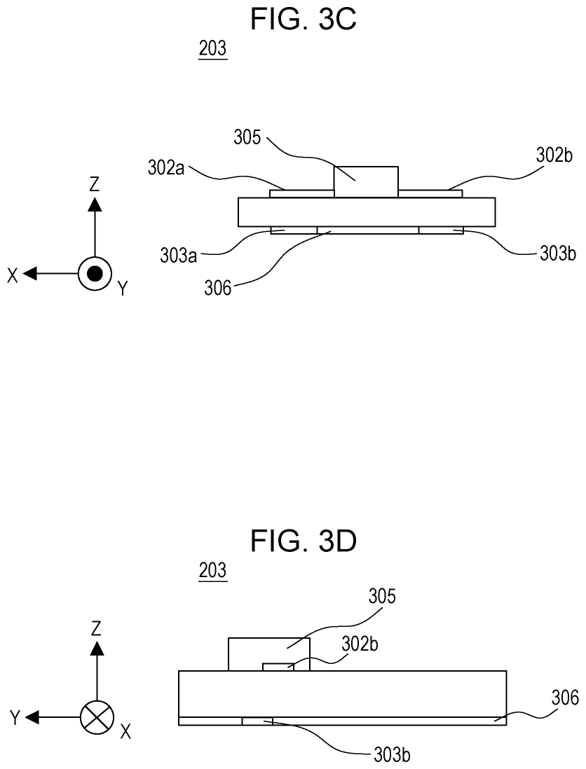

FIG. 3A is a top view that illustrates the antenna board 203 according to this embodiment. FIG. 3B is a bottom view that illustrates the antenna board 203 according to this embodiment. FIG. 3C is a front view that illustrates the antenna board 203 according to this embodiment. FIG. 3D is a side view that illustrates the antenna board 203 according to this embodiment. The front view in FIG. 3C illustrates a surface of the antenna board 203 seen from the Y-axis positive direction, and the side view in FIG. 3D illustrates a side surface of the antenna board 203 seen from an X-axis negative direction.

The antenna board 203 is a single layer double-side board in which copper foil is applied to the two sides of the dielectric that is, for example, Teflon (registered mark), polyphenylene ether, or glass epoxy. Hereinafter, a surface (top surface) of the antenna board 203 facing a Z-axis positive direction may be called a first surface, and a surface (bottom surface) of the antenna board 203 facing a Z-axis negative direction may be called a second surface.

The first surface of the antenna board 203 includes an antenna element 302a and an antenna element 302b. The antenna elements 302a and 302b are formed by, for example, etching on the copper foil.

The first surface of the antenna board 203 may be provided with a radio unit 305.

The second surface of the antenna board 203 includes a ground pattern 306, a ground element 303a, a ground element 303b, a reflector 304a, and a reflector 304b. The ground pattern 306, the ground elements 303a and 303b, and the reflectors 304a and 304b are formed by, for example, etching on the copper foil.

The antenna board 203 is provided with holes 307 through which the screws 208 pass (see FIG. 2E and the like).

A transmitting antenna element 301a includes the antenna element 302a of the first surface and the ground element 303a and the reflector 304a of the second surface, and radiates the transmission waves outputted from the radio unit 305.

The antenna element 302a extends in the X-axis positive direction from the radio unit 305 and is cranked in the Y-axis negative direction to form an L-shape. The ground element 303a has an L-shape that is line-symmetrical to the antenna element 302a about a straight line along the X-axis. The ground element 303a is directly connected to the ground pattern 306.

The length between an opening end of the antenna element 302a in the Y-axis negative direction and an opening end of the ground element 303a in the Y-axis positive direction is set to, for example, 0.5 λe. This setting allows the antenna element 302a and the ground element 303a to form a dipole antenna. λe represents an equivalent wavelength considering reduction of a wavelength of the dielectric of the antenna board 203 and is expressed by λe=λ₀/√εᵣ, where λ₀ represents a wavelength of the transmission waves in a vacuum outputted from the radio unit 305, and εᵣ represents a permittivity of the dielectric.

The reflector 304a is formed to have a space of 0.25 λe in the X-axis negative direction from the antenna element 302a and the ground element 303a. For example, the reflector 304a is formed as a partial projection in the X-axis positive direction from the ground pattern 306. With the reflector 304a formed, the transmitting antenna element 301a has a configuration like the Yagi antenna in which a dipole antenna is provided with a reflector. The transmitting antenna element 301a forms a main lobe in the X-axis positive direction in an X-Y plane.

The receiving antenna element 301b includes the antenna element 302b of the first surface and the ground element 303b and the reflector 304b of the second surface, and outputs the reception waves to the radio unit 305.

The receiving antenna element 301b has a configuration that is line-symmetrical to the transmitting antenna element 301a about a straight line along the Y-axis. The receiving antenna element 301b forms a main lobe in the X-axis negative direction in the X-Y plane.

In the X-Y plane, the direction in which the main lobe of the transmitting antenna element 301a is formed is at an angle of 180 degrees with respect to the direction in which the main lobe of the receiving antenna element 301b is formed. Since the angle formed by the directions in which the main lobes are formed is greater than 90 degrees, the isolation characteristic between the transmitting antenna element 301a and the receiving antenna element 301b is improved.

The configurations of the above-described transmitting antenna element 301a and receiving antenna element 301b are examples, and the present disclosure is not limited thereto. For example, each antenna element may be any antenna as long as it is formed on the antenna board and has a single directionality. For example, the antenna element may be a post-wall horn antenna or a fermi antenna. The transmitting antenna element and the receiving antenna element may not be line-symmetrical to each other about the straight line along the Y-axis. The transmitting antenna element and the receiving antenna element may have antenna configurations different from each other.

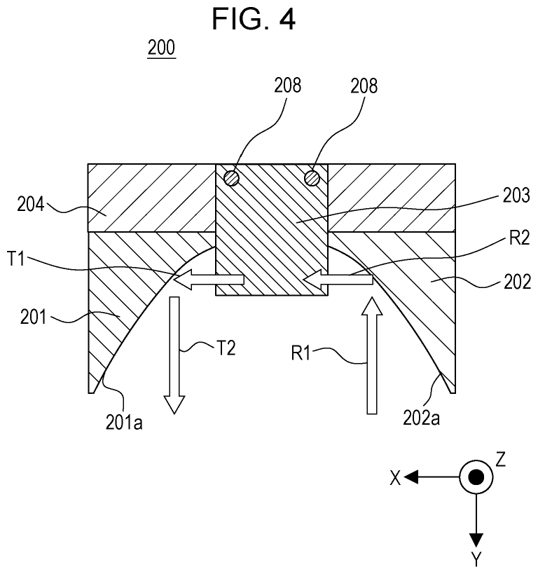

Next, an example of an operation of transmitting the transmission waves and an operation of receiving the reception waves performed by the antenna device 200 according to this embodiment is described. FIG. 4 is a diagram that illustrates an example of operations of the antenna device 200 according to this embodiment. FIG. 4 is the cross-sectional view in FIG. 2E added with an arrow T1, an arrow T2, an arrow R1, and an arrow R2.

The arrow T1 indicates an example of the radiation direction of the radio waves (transmission waves) radiated from the transmitting antenna element 301a on the antenna board 203 (see FIG. 3A and the like). The arrow T2 indicates an example of the traveling direction of the radio waves that are reflected on the first reflecting mirror 201a after the radiation along the arrow T1. The arrow T2 may be called the radiation direction of the transmission waves radiated from the antenna device 200.

The arrow R1 indicates an example of an entering direction of the radio waves (reception waves) to be incident on the second reflecting mirror 202a. The arrow R2 indicates an example of the traveling direction in which the radio waves entering along the arrow R1 are reflected on the second reflecting mirror 202a and received by the receiving antenna element 301b on the antenna board 203 (see FIG. 3A and the like). The arrow R1 may be called the entering direction of the reception waves to be received by the antenna device 200.

The transmission waves are radiated in the X-axis positive direction indicated by the arrow T1 and reflected on the first reflecting mirror 201a, and the direction of the transmission waves is thus changed to the Y-axis positive direction indicated by the arrow T2.

The reception waves entering in the Y-axis negative direction indicated by the arrow R1 are reflected on the second reflecting mirror 202a, and the direction of the reception waves is thus changed to the X-axis negative direction indicated by the arrow R2.

For example, when a line along the first reflecting mirror 201a in a cross-section of the first reflecting unit 201 is a parabola, the transmitting antenna element 301a provided at a focal position of the parabola allows the antenna device 200 to form the main beam in the Y-axis positive direction and radiate the transmission waves. For example, when a line along the second reflecting mirror 202a in a cross-section of the second reflecting unit 202 is a parabola, the receiving antenna element 301b provided at a focal position of the parabola allows the antenna device 200 to form the main beam in the Y-axis positive direction and receive the reception waves.

FIG. 4 presents an example in which the direction of the transmission waves reflected on the first reflecting mirror 201a is changed to the Y-axis positive direction indicated by the arrow T2, and FIG. 4 also presents an example in which the direction of the reception waves entering in the Y-axis negative direction indicated by the arrow R1 is changed to the X-axis positive direction indicated by the arrow R2 when the reception waves are reflected on the second reflecting mirror 202a; however, the present disclosure is not limited thereto. The radiation direction of the transmission waves radiated from the antenna device 200 may not be limited to the Y-axis positive direction, and may be adjusted depending on the direction of the main beam of the transmitting antenna element 301a and/or the shape of the first reflecting mirror 201a. The entering direction of the reception waves received by the antenna device 200 may not be limited to the Y-axis negative direction, and may be adjusted depending on the direction of the main beam of the receiving antenna element 301b and/or the shape of the second reflecting mirror 202a.

FIG. 4 also presents an example in which the radiation direction (arrow T2) of the transmission waves radiated from the antenna device 200 and the entering direction (arrow R1) of the reception waves received by the antenna device 200 are parallel to each other; however, the present disclosure is not limited thereto. The radiation direction of the transmission waves radiated from the antenna device 200 and the entering direction of the reception waves received by the antenna device 200 may form an angle of greater than 0 degree and less than 90 degrees. The angle formed by the radiation direction of the transmission waves and the entering direction of the reception waves is, for example, an acute angle at an intersection of a straight line along the radiation direction of the transmission waves and a straight line along the entering direction of the reception waves.

Directionality patterns of the antenna device 200 based on the above-described operations are described.

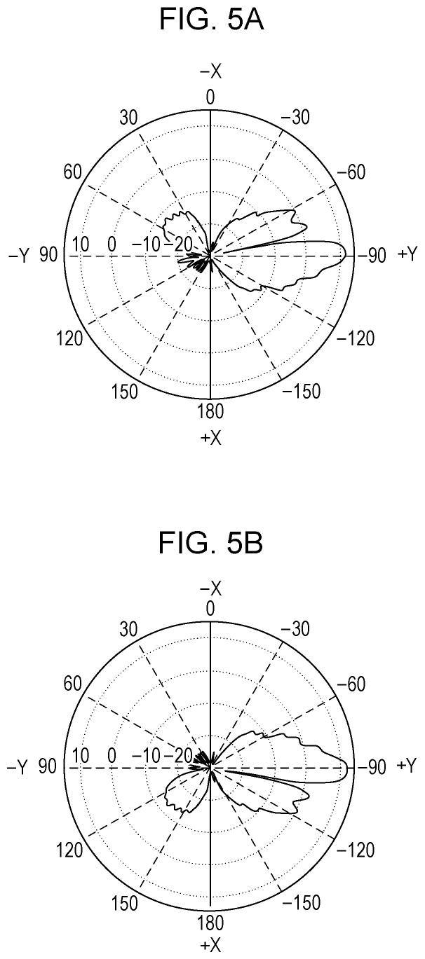

FIG. 5A is a diagram that illustrates an example of a directionality pattern in the transmitting operation of the antenna device 200 according to this embodiment. FIG. 5B is a diagram that illustrates an example of a directionality pattern in the receiving operation of the antenna device 200 according to this embodiment. The directionality patterns illustrated in FIGS. 5A and 5B are results of the electromagnetic field simulation using the finite integration. The operating frequency in the simulation is set to 300 GHz.

As illustrated in FIG. 5A, the directionality pattern in the transmitting operation of the antenna device 200 is a pattern in which the main beam is formed in the Y-axis positive direction. As illustrated in FIG. 5B, the directionality pattern in the receiving operation of the antenna device 200 is a pattern in which the main beam is formed in the Y-axis positive direction. As illustrated in FIGS. 5A and 5B, the antenna device 200 has the greatest antenna gain in the Y-axis positive direction in both the transmitting operation and the receiving operation. For example, the greatest antenna gain is 10 dBi.

For example, as illustrated in FIG. 4, the radiation direction of the radio waves radiated from the transmitting antenna element 301a forms an angle of 180 degrees with respect to the entering direction of the radio waves entering the receiving antenna element 301b. Thus, the radio waves radiated from the transmitting antenna element 301a may be prevented from deflecting to the receiving antenna element 301b, which improves the isolation characteristic between the transmitting antenna element 301a and the receiving antenna element 301b.

The arrangement of the transmitting antenna element 301a and the receiving antenna element 301b illustrated in FIGS. 3A to 4 is an example, and the present disclosure is not limited thereto. Hereinafter, modifications of the arrangement of the transmitting antenna element and the receiving antenna element are described.

### Modification 1

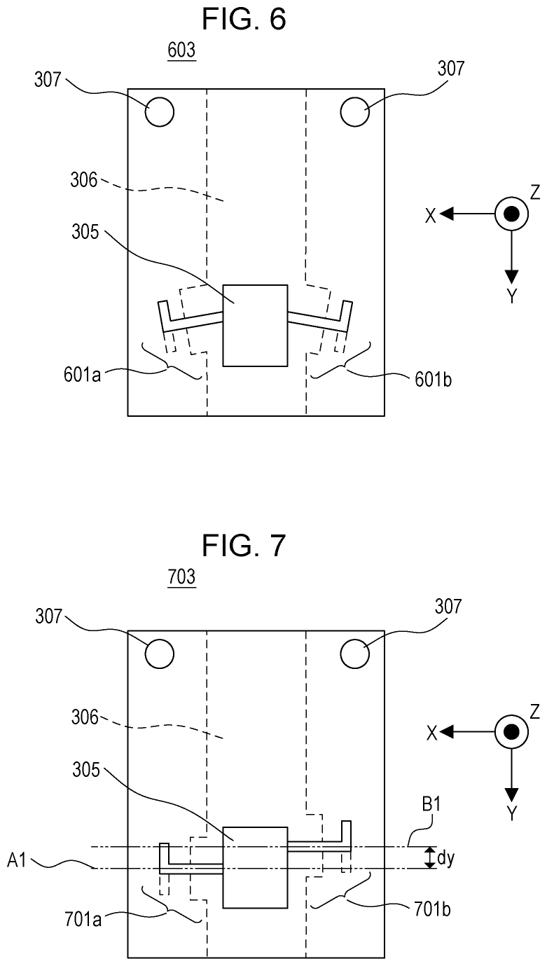

FIG. 6 is a top view that illustrates an example of an antenna board 603 according to a modification 1 of this embodiment. In the antenna board 603 illustrated in FIG. 6, the same constituent as that of the antenna board 203 illustrated in FIGS. 3A to 3D is denoted by the same reference sign, and the description thereof is omitted.

The antenna board 603 includes a transmitting antenna element 601a and a receiving antenna element 601b.

The transmitting antenna element 601a has the same configuration as that of the transmitting antenna element 301a of the antenna board 203. The angle of the arranged transmitting antenna element 601a with respect to the radio unit 305 is different from the angle of the arranged transmitting antenna element 301a with respect to the radio unit 305.

For example, the angle of the arranged transmitting antenna element 601a with respect to the radio unit 305 is in the X-axis positive direction inclined in the Y-axis positive direction.

The receiving antenna element 601b has the same configuration as that of the receiving antenna element 301b of the antenna board 203. The angle of the arranged receiving antenna element 601b with respect to the radio unit 305 is different from the angle of the arranged receiving antenna element 301b with respect to the radio unit 305.

The angle of the arranged receiving antenna element 601b with respect to the radio unit 305 is in the X-axis negative direction inclined in the Y-axis positive direction.

With such a configuration, in the X-Y plane, the direction in which the main lobe of the transmitting antenna element 601a is formed is at an angle less than 180 degrees and greater than 90 degrees with respect to the direction in which the main lobe of the receiving antenna element 601b is formed. Since the angle formed by the direction in which the main lobe of the transmitting antenna element 601a is formed and the direction in which the main lobe of the receiving antenna element 601b is formed is greater than 90 degrees, it is possible to improve the isolation characteristic between the transmitting antenna element 601a and the receiving antenna element 601b. In addition, since the radiation direction of the transmission waves (arrow T1) and/or the traveling direction of the reception waves (arrow R2) in FIG. 4 can be adjusted, it is possible to design the first reflecting mirror 201a and/or the second reflecting mirror 202a more flexibly.

### Modification 2

FIG. 7 is a top view that illustrates an example of an antenna board 703 according to a modification 2 of this embodiment. In the antenna board 703 illustrated in FIG. 7, the same constituent as that of the antenna board 203 illustrated in FIGS. 3A to 3D is denoted by the same reference sign, and the description thereof is omitted.

The antenna board 703 includes a transmitting antenna element 701a and a receiving antenna element 701b.

The transmitting antenna element 701a and the receiving antenna element 701b respectively have the same configurations as those of the transmitting antenna element 301a and the receiving antenna element 301b of the antenna board 203. The relationship of the positions at which the transmitting antenna element 701a and the receiving antenna element 701b are arranged is different from the relationship of the positions at which the transmitting antenna element 301a and the receiving antenna element 301b are arranged.

For example, the transmitting antenna element 701a and the receiving antenna element 701b are arranged at positions offset from each other in the Y-axis direction. For example, in FIG. 7, the receiving antenna element 701b is arranged at a position offset in the Y-axis negative direction from the position of the transmitting antenna element 701a.

FIG. 7 illustrates a straight line A1 passing through the center of an antenna opening of the transmitting antenna element 701a along the X-axis direction and a straight line B1 passing through the center of an antenna opening of the receiving antenna element 701b along the X-axis direction. The center of an antenna opening is, for example, a midpoint of an opening end of the antenna element and an opening end of the ground element.

A space dy between the straight line A1 and the straight line B1 indicates an offset amount in the Y-axis direction between the positions at which the transmitting antenna element 701a and the receiving antenna element 701b are arranged.

With such a configuration, the transmitting antenna element 701a forms the main lobe in the X-axis positive direction, and the receiving antenna element 701b forms the main lobe in the X-axis negative direction. The transmitting antenna element 701a and the receiving antenna element 701b are arranged offset in a direction (Y-axis direction) perpendicular to the direction (X-axis direction) in which the main lobes are formed, and thus it is possible to improve the isolation characteristic.

For example, even when the transmitting antenna element 701a forms a side lobe, which is called a back lobe, in a direction that is 180 degrees opposite to the main lobe, the receiving antenna element 701b is arranged at a position offset in the Y-axis direction, and thus it is possible to prevent the deterioration of the isolation characteristic.

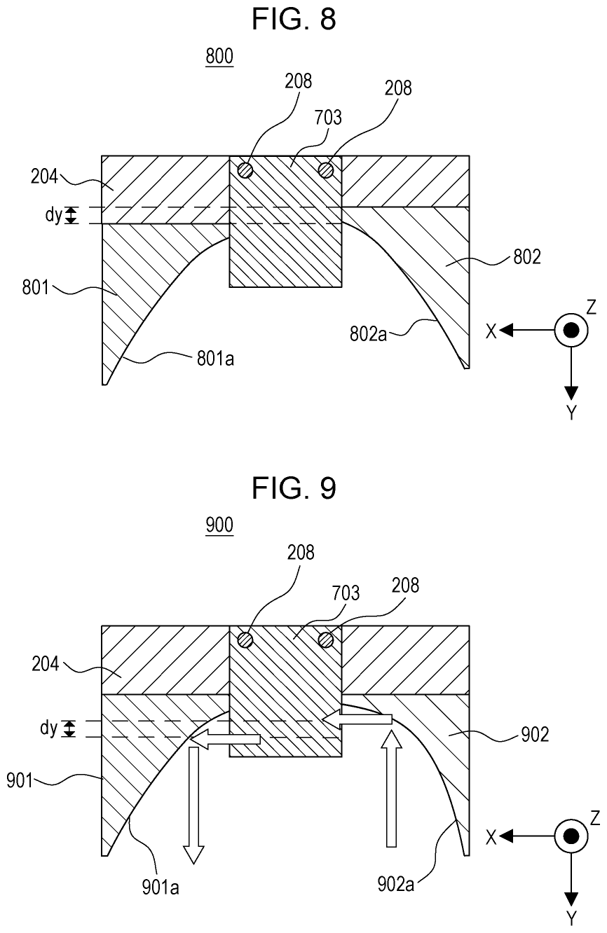

Since the offset in the Y-axis direction is provided between the transmitting antenna element 701a and the receiving antenna element 701b in the antenna board 703 illustrated in FIG. 7, the configuration illustrated in FIG. 8 may be adopted in which a focal position of the first reflecting unit and a focal position of the second reflecting unit are offset in the Y-axis direction according to the above-described offset in the Y-axis direction, for example.

FIG. 8 is a diagram that illustrates a first example of the antenna device including the antenna board 703 illustrated in FIG. 7. An antenna device 800 illustrated in FIG. 8 includes, for example, the antenna board 703, a first reflecting unit 801, and a second reflecting unit 802.

The first reflecting unit 801 and the second reflecting unit 802 respectively have the same configurations as those of the first reflecting unit 201 and the second reflecting unit 202 illustrated in FIGS. 2A to 2E. For example, a first reflecting mirror 801a of the first reflecting unit 801 reflects the transmission waves radiated from the transmitting antenna element 701a of the antenna board 703 in the Y-axis positive direction. A second reflecting mirror 802a of the second reflecting unit 802 reflects the reception waves entering the antenna device 800 from the Y-axis positive direction to the receiving antenna element 701b.

The positional relationship between the first reflecting unit 801 and the second reflecting unit 802 is different from that of the first reflecting unit 201 and the second reflecting unit 202.

In the antenna board 703, the receiving antenna element 701b is arranged at a position offset by the offset amount dy in the Y-axis negative direction from the position of the transmitting antenna element 701a. In the antenna device 800 illustrated in FIG. 8, the second reflecting unit 802 is arranged at a position offset by the offset amount dy in the Y-axis negative direction from the position of the first reflecting unit 801 according to the offset amount dy.

In FIG. 8, focal positions of the first reflecting mirror 801a and the second reflecting mirror 802a are adjusted by adjusting the positional relationship between the first reflecting unit 801 and the second reflecting unit 802 according to the offset amount dy in the Y-axis direction between the transmitting antenna element 701a and the receiving antenna element 701b.

This configuration makes it possible to respectively provide the transmitting antenna element 701a and the receiving antenna element 701b at the focal positions of the first reflecting unit 801 and the second reflecting unit 802, and thus it is possible to improve the antenna gain.

FIG. 9 is a diagram that illustrates a second example of the antenna device including the antenna board 703 illustrated in FIG. 7. An antenna device 900 illustrated in FIG. 9 includes the antenna board 703, a first reflecting unit 901, and a second reflecting unit 902.

The first reflecting unit 901 has the same configuration as that of the first reflecting unit 201 illustrated in FIGS. 2A to 2E. For example, a first reflecting mirror 901a of the first reflecting unit 901 reflects the transmission waves radiated from the transmitting antenna element 701a of the antenna board 703 into the Y-axis positive direction.

The second reflecting unit 902 is arranged at the same position as that of the second reflecting unit 202 illustrated in FIGS. 2A to 2E. A second reflecting mirror 902a of the second reflecting unit 902 reflects the reception waves entering the antenna device 900 from the Y-axis positive direction to the receiving antenna element 701b.

The shape of the second reflecting mirror 902a included in the second reflecting unit 902 is different from that of the second reflecting mirror 202a.

In the antenna board 703, the receiving antenna element 701b is arranged at a position offset by the offset amount dy in the Y-axis negative direction from the position of the transmitting antenna element 701a. In the antenna device 900 illustrated in FIG. 9, a focal point of a parabola along the second reflecting mirror 902a in a cross-section of the second reflecting unit 902 is changed according to the offset amount dy.

In FIG. 9, focal positions are adjusted by adjusting the shapes of the first reflecting mirror 901a and/or the second reflecting mirror 902a according to the offset amount dy in the Y-axis direction between the transmitting antenna element 701a and the receiving antenna element 701b.

This configuration makes it possible to respectively provide the transmitting antenna element 701a and the receiving antenna element 701b at the focal positions of the first reflecting mirror 901a and the second reflecting mirror 902a, and thus it is possible to improve the antenna gain.

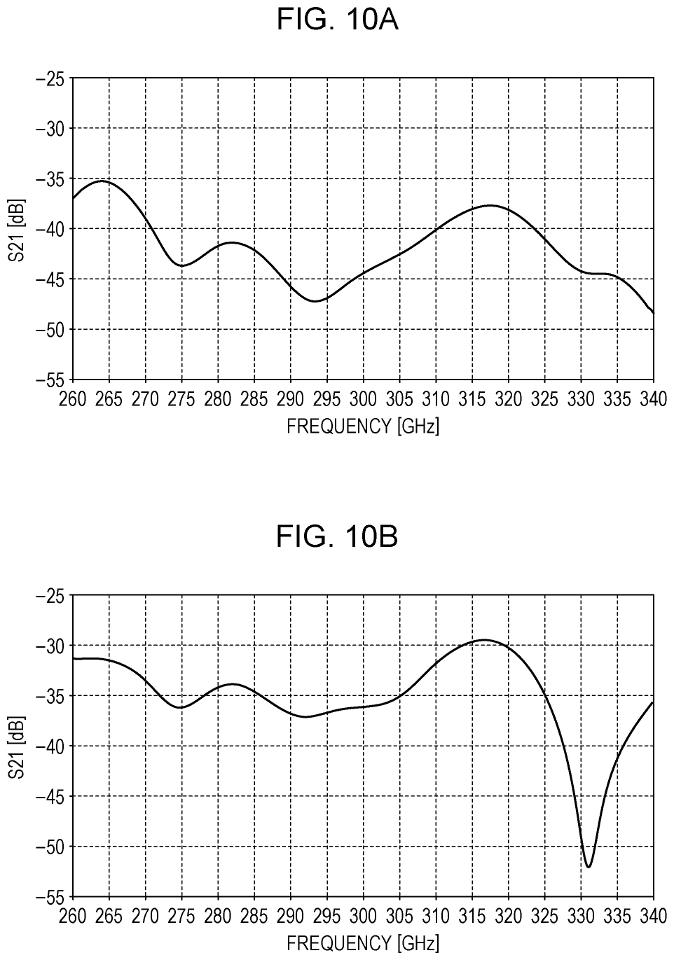

Next, an example of the isolation characteristic of the antenna device 800, which includes the antenna board 703 in which the offset in the Y-axis direction is provided between the transmitting antenna element 701a and the receiving antenna element 701b, the first reflecting unit 801, and the second reflecting unit 802, is described with reference to FIGS. 10A and 10B.

FIG. 10A is a diagram that illustrates an example of the isolation characteristic of the antenna device 800. FIG. 10B is a diagram that illustrates an example of the isolation characteristic of a comparative example of FIG. 10A. In FIGS. 10A and 10B, the horizontal axis represents an operating frequency, and the vertical axis represents a characteristic of S21, which is an S-parameter representing the isolation characteristic.

FIG. 10A illustrates the characteristic that is obtained when offset amount dy=0.2 mm is set. The comparison example in FIG. 10B illustrates the isolation characteristic that is obtained when the offset in the Y-axis direction is not provided between the transmitting antenna element 701a and the receiving antenna element 701b (that is, when offset amount dy=0).

The S21 characteristic represents the transmission characteristic that is obtained when feed ports are set at a connecting position of the transmitting antenna element 701a and the radio unit 305 and a connecting position of the receiving antenna element 701b and the radio unit 305. The lower a value of the S21 characteristic in the vertical axis, the higher the isolation characteristic.

For example, when the operating frequency is 300 GHz, the S21 characteristic in FIG. 10A is −44 dB, and the S21 characteristic in FIG. 10B is −37 dB. When the operating frequency is 300 GHz and the offset of offset amount dy=0.2 mm is set, the isolation characteristic is improved by about 7 dB comparing with the case in which no offset is provided (that is, when offset amount dy=0).

As described above, in the antenna device according to this embodiment, the transmitting antenna element (first antenna) and the receiving antenna element (second antenna) are formed on the antenna board such that the direction of the main beam of the transmitting antenna element forms an angle of greater than 90 degrees with respect to the direction of the main beam of the receiving antenna element. In addition, the antenna device includes the first reflecting mirror that changes the direction of the main beam of the transmitting antenna element into a desired direction and the second reflecting mirror that changes the direction of the main beam of the receiving antenna element into a desired direction.

With this configuration, the transmission waves radiated from the transmitting antenna element may be prevented from deflecting to the receiving antenna element, which makes it possible to improve the isolation characteristic.

According to this embodiment, the transmitting antenna element and the receiving antenna element are formed on the same plane of the antenna board. This configuration makes it possible to implement a simpler configuration than a case of providing the antenna elements on multiple planes.

According to this embodiment, the connecting lines from the transmitting antenna element and the receiving antenna element to the position of the antenna board provided with the radio unit are comparatively short. This configuration makes it possible to prevent the power loss in the connecting lines, and thus it is possible to improve the antenna gain.

In the drawings described above, some of the duplicated reference signs for the same configurations are omitted.

The term “. . . unit” used in the descriptions of the above embodiments may be replaced by other terms such as “. . . circuitry,” “. . . device,” and “. . . module.”

Each functional block used in the description of each embodiment described above is implemented typically as an LSI such as an integrated circuit. The integrated circuit may control each functional block used in the description of each embodiment and may be provided with input and output. The LSI may be individually formed as chips, or one chip may be formed so as to include a part or all of the functional blocks. The LSI here may be referred to as an IC, a system LSI, a super LSI, or an ultra LSI depending on a difference in the degree of integration.

However, the technique of implementing an integrated circuit is not limited to the LSI and may be implemented by using a dedicated circuit or a general-purpose processor. An FPGA (Field Programmable Gate Array) that can be programmed after the manufacture of the LSI or a reconfigurable processor in which the connections and the settings of circuit cells disposed inside the LSI can be reconfigured may be used.

If future integrated circuit technology replaces LSIs as a result of the advancement of semiconductor technology or other derivative technology, the functional blocks could be integrated using the future integrated circuit technology. Biotechnology can also be applied.

The present disclosure may be implemented as a radio communication device or a control method executed by a control device. The present disclosure may also be implemented as a program that allows a computer to execute the control method. In addition, the present disclosure may be implemented as a storage medium storing the program that can be read by the computer. That is, the present disclosure may be implemented as any categories including the device, method, program, and storage medium.

The various embodiments are described above with reference to the drawings; however, it is obvious that the present disclosure is not limited to the examples. It is apparent that those skilled in the art can conceive various modifications and corrections within a scope of the claims, and it should be naturally understood that those modifications and corrections belong to the technical scope of the present disclosure. The constituents of the above-described embodiments may be arbitrary combined with each other without departing from the gist of the present disclosure.

### SUMMARY OF PRESENT DISCLOSURE

An antenna device of the present disclosure includes: a first antenna that is provided on a board and forms a main lobe in a first direction along a plane of the board; a second antenna that is provided on the board and forms a main lobe in a second direction along the plane of the board, the second direction forming an angle of greater than 90 degrees and equal to or less than 180 degrees with respect to the first direction; a first reflecting mirror that changes a traveling direction of radio waves radiated in the first direction from the first antenna into a third direction; and a second reflecting mirror that changes a traveling direction of radio waves entering from a fourth direction into the second direction.

In the antenna device of the present disclosure, the first antenna is arranged at a first focal position of the first reflecting mirror, and the second antenna is arranged at a second focal position of the second reflecting mirror.

In the antenna device of the present disclosure, the angle formed by the first direction and the second direction is 180 degrees.

In the antenna device of the present disclosure, the first antenna is arranged on a first straight line along the first direction, and the second antenna is arranged on a second straight line offset from the first straight line.

In the antenna device of the present disclosure, positions of the first reflecting mirror and the second reflecting mirror are adjusted according to an offset amount between the first straight line and the second straight line.

In the antenna device of the present disclosure, shapes of the first reflecting mirror and the second reflecting mirror are adjusted according to an offset amount between the first straight line and the second straight line.

In the antenna device of the present disclosure, a straight line along the third direction and a straight line along the fourth direction are parallel to each other or form an angle of greater than 0 degree and less than 90 degrees.

A radio device of the present disclosure includes: a board; a radio circuit provided on the board; a first antenna that is provided on the board and forms a main lobe in a first direction along a plane of the board; a second antenna that is provided on the board and forms a main lobe in a second direction along the plane of the board, the second direction forming an angle of greater than 90 degrees and equal to or less than 180 degrees with respect to the first direction; a first reflecting mirror that changes a radiation direction of radio waves radiated in the first direction from the first antenna into a third direction; and a second reflecting mirror that changes a radiation direction of radio waves entering from a fourth direction into the second direction.

The present disclosure is suitable for use in a radio communication device.

What is claimed is:

1. An antenna device, comprising:
a first antenna that is provided on a board and forms a main lobe in a first direction along a plane of the board;
a second antenna that is provided on the board and forms a main lobe in a second direction along the plane of the board, the second direction forming an angle of greater than 90 degrees and equal to or less than 180 degrees with respect to the first direction;
a first reflecting mirror that changes a traveling direction of radio waves radiated in the first direction from the first antenna into a third direction; and
a second reflecting mirror that changes a traveling direction of radio waves entering from a fourth direction into the second direction.

2. The antenna device according to claim 1, wherein
the first antenna is arranged at a first focal position of the first reflecting mirror, and
the second antenna is arranged at a second focal position of the second reflecting mirror.

3. The antenna device according to claim 1, wherein
the angle formed by the first direction and the second direction is 180 degrees.

4. The antenna device according to claim 3, wherein
the first antenna is arranged on a first straight line along the first direction, and
the second antenna is arranged on a second straight line offset from the first straight line.

5. The antenna device according to claim 4, wherein
positions of the first reflecting mirror and the second reflecting mirror are adjusted according to an offset amount between the first straight line and the second straight line.

6. The antenna device according to claim 4, wherein
shapes of the first reflecting mirror and the second reflecting mirror are adjusted according to an offset amount between the first straight line and the second straight line.

7. The antenna device according to claim 1, wherein
a straight line along the third direction and a straight line along the fourth direction are parallel to each other or form an angle of greater than 0 degree and less than 90 degrees.

8. A radio device, comprising:
a board;
a radio circuit provided on the board;
a first antenna that is provided on the board and forms a main lobe in a first direction along a plane of the board;
a second antenna that is provided on the board and forms a main lobe in a second direction along the plane of the board, the second direction forming an angle of greater than 90 degrees and equal to or less than 180 degrees with respect to the first direction;
a first reflecting mirror that changes a radiation direction of radio waves radiated in the first direction from the first antenna into a third direction; and
a second reflecting mirror that changes a radiation direction of radio waves entering from a fourth direction into the second direction.
